(19) United States
(12) Patent Application Publication
(10) Pub. No.: US 2014/0328411 A1
(43) Pub. Date: Nov. 6, 2014

(54) VIDEO ENCODING METHOD AND APPARATUS AND VIDEO DECODING METHOD AND APPARTUS USING UNIFIED SYNTAX FOR PARALLEL PROCESSING

(71) Applicant: SAMSUNG ELECTRONICS CO., LTD., Suwon-si (KR)

(72) Inventors: Seung-soo JEONG, Seoul (KR); Young-o PARK, Seoul (KR); Chan-yul KIM, Seongnam-si (KR); Jeong-hoon PARK, Seoul (KR); Jae-hyun KIM, Seoul (KR)

(73) Assignee: SAMSUNG ELECTRONICS CO., LTD., Suwon-si (KR)

(21) Appl. No.: 14/336,285

(22) Filed: Jul. 21, 2014

Related U.S. Application Data
(63) Continuation of application No. PCT/KR2013/000491, filed on Jan. 21, 2013.
(60) Provisional application No. 61/588,690, filed on Jan. 20, 2012.

(51) Int. Cl. H04N 19/436; H04N 19/70

(52) U.S. Cl. CPC H04N 19/00521; H04N 19/00884
USPC 375/240.26

(57) ABSTRACT

Provided are a video encoding method and apparatus and a video decoding method and apparatus using unified syntax for parallel processing. The video decoding method includes: obtaining a first data unit parallel processing flag indicating whether parallel processable data is included in a first data unit from a first data unit header including encoding information of the first data unit that constitutes video included in a bitstream; determining whether parallel processable data is included in the first data unit based on the first data unit parallel processing flag; and when it is determined that parallel processable data is included in the first data unit, obtaining a second data unit parallel processing flag indicating whether parallel processable data is included in a second data unit whose level is lower than a level of the first data unit from a second data unit header including encoding information of the second data unit.

### RELATED APPLICATIONS

This is a continuation application of PCT/KR2013/000491 filed on Jan. 21, 2013 which claims the benefit of U.S. Provisional Application 61/588,690, filed on Jan. 20, 2012, in the United States Patent and Trademark Office, the disclosures of which are hereby incorporated herein in their entirety by reference.

### BACKGROUND

1. Field

Exemplary embodiments relate to video encoding and decoding for parallel processing.

2. Related Art

As digital display technology has recently been developed and the high definition digital TV age has arrived, a new codec for processing large amounts of video data is being proposed. Also, as hardware performance has recently been improved, a central processing unit (CPU) or a graphics processing unit (GPU) that performs video image processing is configured to include multiple cores and is able to perform parallel image data processing.

### SUMMARY

Exemplary embodiments provide a video encoding method and apparatus and a video decoding method and apparatus using parallel processing information that is unified according to video data units for parallel processing of video data.

Flag information for systematically performing parallel processing is added to data units having an upper level and a lower level.

According to an exemplary embodiment, a video decoding method is provided. The method includes: obtaining a first data unit parallel processing flag indicating whether parallel processable data is included in a first data unit from a first data unit header including encoding information of the first data unit that constitutes a video included in a bitstream; determining whether parallel processable data is included in the first data unit based on the first data unit parallel processing flag; and when it is determined that parallel processable data is included in the first data unit, obtaining a second data unit parallel processing flag indicating whether parallel processable data is included in a second data unit whose level is lower than a level of the first data unit from a second data unit header including encoding information of the second data unit.

According to an exemplary embodiment, a video decoding apparatus is provided. The apparatus includes: a parallel processing information obtainer that obtains a first data unit parallel processing flag indicating whether parallel processable data is included in a first data unit that constitutes a video included in a bitstream from a first data unit header including encoding information of the first data unit, and when it is determined that parallel processable data is included in the first data unit based on the first data unit parallel processing flag, obtains a second data unit parallel processing flag indicating whether parallel processable data is included in a second data unit whose level is lower than a level of the first data unit from a second data unit header including encoding information of the second data unit; and a parallel processing determiner that determines a parallel processable data unit included in the video based on the obtained first data unit parallel processing flag and the obtained second data unit parallel processing flag.

According to an exemplary embodiment, a video encoding method is provided. The video encoding method includes: obtaining encoded data of a first data unit that constitutes a video and a second data unit whose level is lower than a level of the first data unit; encoding a first data unit parallel processing flag indicating whether parallel processable data is included in the first data unit and outputting the encoded first data unit parallel processing flag to a first data unit header including encoding information of the first data unit; and when parallel processable data is included in the first data unit, encoding a second data unit parallel processing flag indicating whether parallel processable data is included in the second data unit and outputting the encoded second data unit parallel processing flag to a second data unit header.

According to an exemplary embodiment, a video encoding apparatus is provided. The video encoding apparatus includes: a parallel processing determiner that obtains encoded data of a first data unit that constitutes a video and a second data unit whose level is lower than a level of the first data unit, and determines whether parallel processable data is included in the first data unit and the second data unit; and a parallel processing information output unit that encodes a first data unit parallel processing flag indicating whether parallel processable data is included in the first data unit and outputs the encoded first data unit parallel processing flag to a first data unit header including encoding information of the first data unit, and when parallel processable data is included in the first data unit, encodes a second data unit parallel processing flag indicating whether parallel processable data is included in the second data unit and outputs the encoded second data unit parallel processing flag to a second data unit header.

According to exemplary embodiments, it may be previously determined whether data that may be parallel processed (hereinafter, referred to as parallel processable data) exists in each data unit when data is parsed in an order from an upper data unit to a lower data unit in a decoder by using unified and systematic parallel processing information in an order from an upper data layer to a lower data layer. According to an exemplary embodiment, parallel image processing is possible by detecting parallel processable data and dividing and assigning the data to multiple cores of the decoder.

### BRIEF DESCRIPTION OF THE DRAWINGS

FIG. 1 is a block diagram illustrating a video encoding apparatus according to an exemplary embodiment.

FIG. 2 is a block diagram illustrating a video decoding apparatus according to an exemplary embodiment.

FIG. 3 is a diagram for explaining a concept of coding units according to an exemplary embodiment.

FIG. 4 is a block diagram illustrating an image encoder based on coding units, according to an exemplary embodiment.

FIG. 5 is a block diagram illustrating an image decoder based on coding units, according to an exemplary embodiment.

FIG. 6 is a diagram illustrating deeper coding units according to depths and partitions, according to an exemplary embodiment.

FIG. 7 is a diagram for explaining a relationship between a coding unit and transformation units, according to an exemplary embodiment.

FIG. 8 is a diagram for explaining encoding information of coding units corresponding to a coded depth, according to an exemplary embodiment.

FIG. 9 is a diagram illustrating deeper coding units according to depths, according to an exemplary embodiment.

FIGS. 10 through 12 are diagrams for explaining a relationship between coding units, prediction units, and frequency transformation units, according to an exemplary embodiment.

FIG. 13 is a diagram for explaining a relationship between a coding unit, a prediction unit, and a transformation unit according to encoding mode information of Table 1.

FIG. 14 is a reference diagram for explaining a concept of parallel processing of video data units, according to an exemplary embodiment.

FIG. 15 is a block diagram illustrating an entropy encoding apparatus according to an exemplary embodiment.

FIG. 16 is a reference diagram for explaining a slice unit according to an exemplary embodiment.

FIG. 17 is a reference diagram for explaining a slice unit according to another exemplary embodiment.

FIG. 18 is a reference diagram for explaining a tile unit according to an exemplary embodiment.

FIG. 19 is a reference diagram for explaining wavefront parallel processing (WPP) according to an exemplary embodiment.

FIG. 20 is a flowchart illustrating a process performed by a parallel processing information output unit 1520 to set a flag indicating whether data that may be parallel processed exists in each data unit, according to an exemplary embodiment.

FIG. 21 is a diagram illustrating a sequence parameter set (SPS) according to an exemplary embodiment.

FIG. 22 is a diagram illustrating a picture parameter set (PPS) according to an exemplary embodiment.

FIG. 23 is a diagram illustrating parallel processing information parallel_processing_param( ) according to an exemplary embodiment.

FIG. 24 is a flowchart illustrating a video encoding method according to an exemplary embodiment.

FIG. 25 is a block diagram illustrating an entropy decoding apparatus according to an exemplary embodiment.

FIG. 26 is a flowchart illustrating a video decoding method according to an exemplary embodiment.

FIG. 27 is a detailed flowchart illustrating a video decoding method for parallel processing, according to an exemplary embodiment.

### DETAILED DESCRIPTION OF EXEMPLARY EMBODIMENTS

Exemplary embodiments will now be explained more fully with reference to the accompanying drawings.

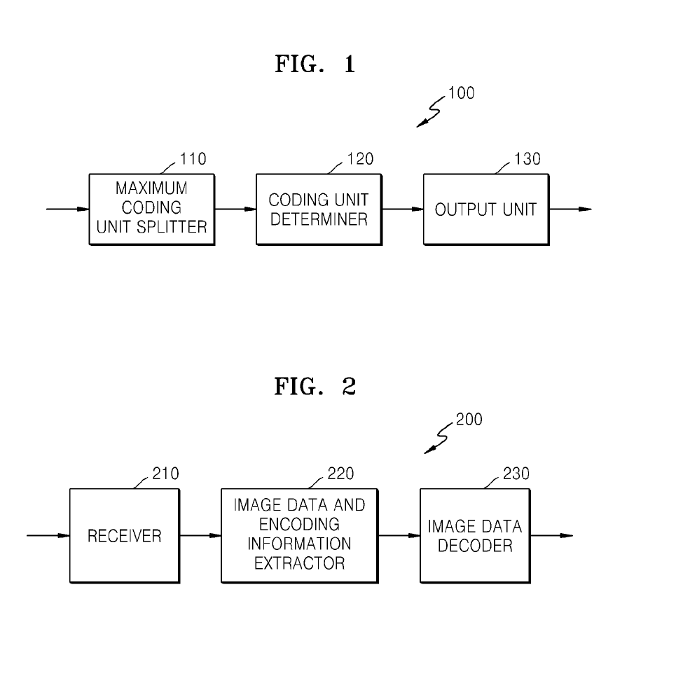

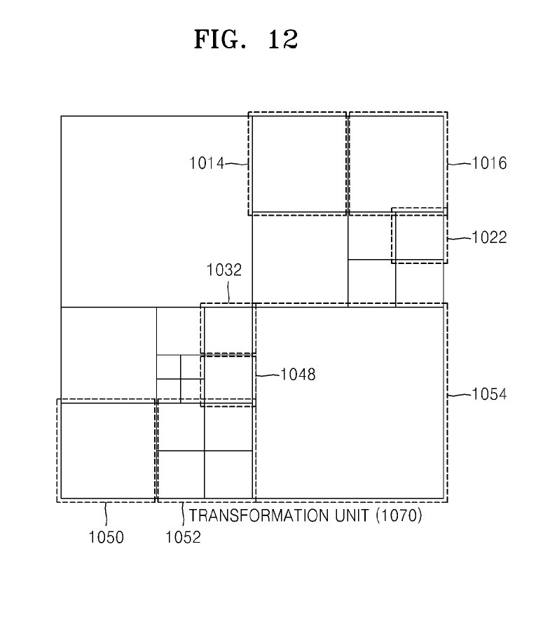

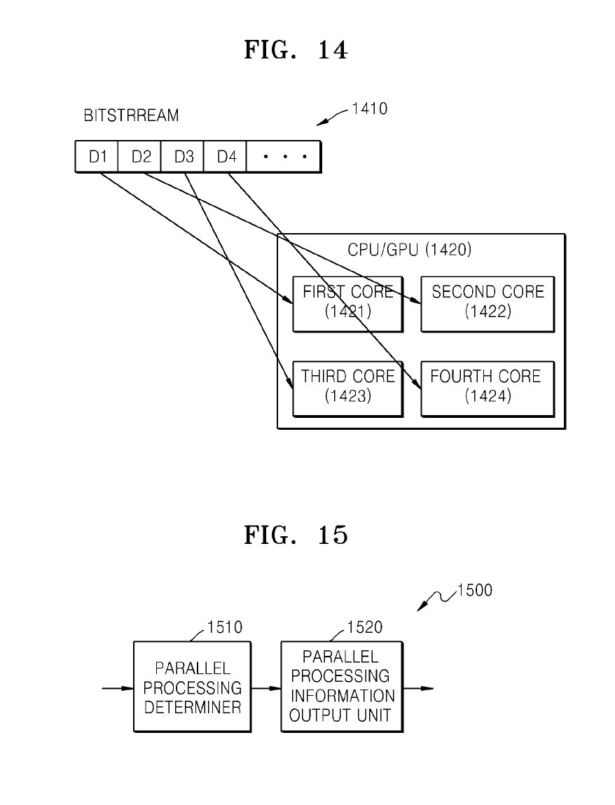

Video encoding and video decoding based on data units that are spatially hierarchical according to an exemplary embodiment will be explained with reference to FIGS. 1 through 13. Video encoding and video decoding using a unified syntax for parallel processing according to an exemplary embodiment will be explained with reference to FIGS. 14 through 27.

FIG. 1 is a block diagram illustrating a video encoding apparatus 100 according to an exemplary embodiment.

The video encoding apparatus 100 includes a maximum coding unit splitter 110, a coding unit determiner 120, and an output unit 130.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an embodiment may be characterized by a maximum size and a depth. The depth denotes a number of times the coding unit is spatially split from the maximum coding unit, and as the depth increases, deeper coding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit increases, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an embodiment is split according to depths, the image data of a spatial domain included in the maximum coding unit may be hierarchically classified according to depths.

A maximum depth and a maximum size of a coding unit, which limit a total number of times a height and a width of the maximum coding unit are hierarchically split may be preset.

The coding unit determiner 120 encodes at least one split region obtained by splitting a region of the maximum coding unit according to depths, and determines a depth to output finally encoded image data according to the at least one split region. In other words, the coding unit determiner 120 determines a coded depth by encoding the image data in the deeper coding units according to depths, according to the maximum coding unit of the current picture, and selecting a depth having a least encoding error. The determined coded depth and the image data according to the maximum coding unit are output to the output unit 130.

The image data in the maximum coding unit is encoded based on the deeper coding units corresponding to at least one depth equal to or less than the maximum depth, and results of encoding the image data are compared based on each of the deeper coding units. A depth having a least encoding error may be selected after comparing encoding errors of the deeper coding units. At least one coded depth may be determined for each maximum coding unit.

As a coding unit is hierarchically split according to depths, a size of the maximum coding unit is split and a number of coding units increases. Also, even if coding units correspond to the same depth in one maximum coding unit, an encoding error of data of each of the coding units and it is determined whether to split each of the coding units corresponding to the same depth to a lower depth. Accordingly, even when data is included in one maximum coding unit, the encoding errors may differ according to regions in the one maximum coding unit, and thus the coded depths may differ according to regions in the data. Thus, one or more coded depths may be set in one maximum coding unit, and the data of the maximum coding unit may be divided according to coding units of at least one coded depth.

Accordingly, the coding unit determiner 120 according to an embodiment may determine coding units having a tree structure included in a current maximum coding unit. The ‘coding units having a tree structure’ according to an embodiment include coding units corresponding to a depth determined to be the coded depth, from among all deeper coding units included in the current maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an embodiment is an index related to a number of times splitting is performed from a maximum coding unit to a minimum coding unit. A first maximum depth according to an embodiment may denote a total number of times splitting is performed from the maximum coding unit to the minimum coding unit. A second maximum depth according to an embodiment may denote a total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and frequency transformation may be performed according to the maximum coding unit. The prediction encoding and the frequency transformation are also performed based on the deeper coding units according to a depth equal to or depths less than the maximum depth, according to the maximum coding unit.

Since a number of deeper coding units increases whenever the maximum coding unit is split according to depths, encoding including the prediction encoding and the frequency transformation has to be performed on all of the deeper coding units generated as the depth increases. For convenience of explanation, the prediction encoding and the frequency transformation will now be explained based on a coding unit of a current depth, in at least one maximum coding unit.

The video encoding apparatus 100 according to an embodiment may variously select a size or shape of a data unit for encoding the image data. In order to encode the image data, operations, such as prediction encoding, frequency transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit in order to perform the prediction encoding on the image data in the coding unit.

In order to perform prediction encoding in the maximum coding unit, the prediction encoding may be performed based on a coding unit corresponding to a coded depth, i.e., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit.

For example, when a coding unit having a size of 2N×2N (where N is a positive integer) is no longer split and becomes a prediction unit having a size of 2N×2N, a size of a partition may be 2N×2N, 2N×N, N×2N, or N×N. Examples of a partition type according to an embodiment include symmetrical partitions that are obtained by symmetrically splitting a height or width of the prediction unit, partitions obtained by asymmetrically splitting the height or width of the prediction unit, such as in 1:n or n:1, partitions that are obtained by geometrically splitting the prediction unit, and partitions having arbitrary shapes.

A prediction mode of the prediction unit may be at least one selected from an intra mode, a inter mode, and a skip mode. For example, the intra mode or the inter mode may be performed on the partition having a size of 2N×2N, 2N×N, N×2N, or N×N. Also, the skip mode may be performed only on the partition having a size of 2N×2N. The encoding is independently performed on one prediction unit in a coding unit, thereby selecting a prediction mode having a least encoding error.

The video encoding apparatus 100 may also perform the frequency transformation on the image data in a coding unit based not only on the coding unit for encoding the image data, but also based on a data unit that is different from the coding unit.

In order to perform the frequency transformation in the coding unit, the frequency transformation may be performed based on a data unit having a size less than or equal to the coding unit. For example, the data unit for the frequency transformation may include a data unit for an intra mode and a data unit for an inter mode.

A data unit used as a base of the frequency transformation will now be referred to as a ‘transformation unit’. Similarly to the coding unit, the transformation unit in the coding unit may be recursively split into smaller sized regions, and thus residual data in the coding unit may be divided according to the transformation unit having the tree structure according to transformation depths.

A transformation depth indicating a number of times splitting is performed to reach the transformation unit by splitting the height and width of the coding unit may also be set in the transformation unit. For example, in a current coding unit having a size of 2N×2N, a transformation depth may be 0 when a size of a transformation unit is 2N×2N, may be 1 when a size of a transformation unit is N×N, and may be 2 when a size of a transformation unit is N/2×N/2. That is, the transformation unit having the tree structure may also be set according to transformation depths.

Encoding information according to coding units corresponding to a coded depth requires not only information about the coded depth, but also about information related to prediction encoding and frequency transformation. Accordingly, the coding unit determiner 120 not only determines a coded depth having a minimum encoding error, but also determines a partition type in a prediction unit, a prediction mode according to prediction units, and a size of a transformation unit for frequency transformation.

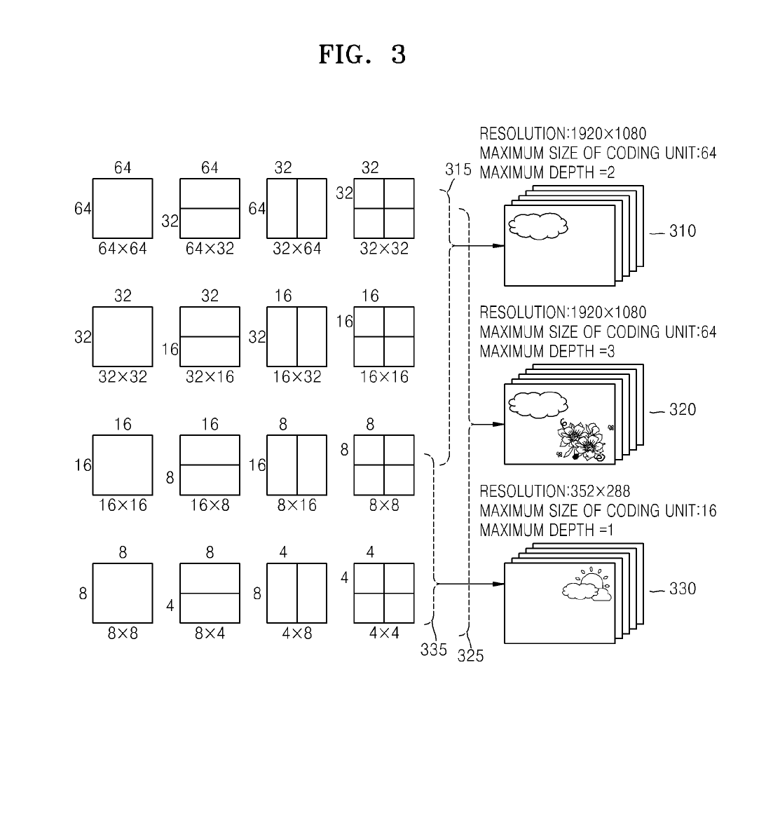

Coding units having a tree structure in a maximum coding unit and a method of determining a partition according to an embodiment will be explained below in detail with reference to FIGS. 3 through 12.

The coding unit determiner 120 may measure an encoding error of deeper coding units according to depths by using Rate-Distortion (RD) Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to the coded depth may include information about the coded depth, about the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus the split information may be defined not to split the current coding unit to a lower depth. Alternatively, if the current depth of the current coding unit is not the coded depth, the encoding has to be performed on the coding unit of the lower depth, and thus the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the data of the maximum coding unit may be different according to locations since the image data is hierarchically split according to depths, and thus information about the coded depth and the encoding mode may be set for the data.

Accordingly, the output unit 130 may assign encoding information about a corresponding coded depth and an encoding mode to at least one of the coding unit, the prediction unit, and a minimum unit included in the maximum coding unit.

The minimum unit according to an embodiment is a rectangular data unit obtained by splitting the minimum coding unit constituting the lowermost depth by 4. Alternatively, the minimum unit may be a maximum rectangular data unit that may be included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode. Also, information about a maximum size of the coding unit defined according to pictures, slices, or group of pictures (GOP's), and information about a maximum depth may be inserted into a header of a bitstream.

According to a simplest embodiment of the video encoding apparatus 100, the deeper coding unit is a coding unit obtained by dividing a height or width of a coding unit of an upper depth, which is one layer above, by two. In other words, when a size of the coding unit of the current depth is 2N×2N, a size of the coding unit of the lower depth is N×N. Also, the coding unit of the current depth having a size of 2N×2N may include a maximum number of 4 coding units having a size of N×N of the lower depth.

Accordingly, the video encoding apparatus 100 according to an embodiment may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and frequency transformations, an optimum encoding mode may be determined considering image characteristics of the coding unit of various image sizes.

Thus, if an image having a very high resolution or a large data amount is encoded in a macroblock, a number of macroblocks per picture excessively increases. Accordingly, a number of pieces of compressed information generated for each macroblock increases, and thus it is difficult to transmit the compressed information and data compression efficiency decreases. However, by using the video encoding apparatus 100 according to an embodiment, image compression efficiency may be improved since a coding unit is adjusted in consideration of characteristics of an image and a maximum size of a coding unit is increased in consideration of a size of the image.

FIG. 2 is a block diagram illustrating a video decoding apparatus 200 according to an exemplary embodiment.

The video decoding apparatus 200 according to an embodiment includes a receiver 210, an image data and encoding information extractor 220, and an image data decoder 230. Definitions of various terms, such as a coding unit, a depth, a prediction unit, a transformation unit, and information about various encoding modes, for various operations of the video decoding apparatus 200 according to an embodiment are identical to those explained with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture.

Also, the image data and encoding information extractor 220 extracts information about a coded depth and an encoding mode for the coding units having the tree structure according to each maximum coding unit, from the parsed bitstream. The extracted information about the coded depth and the encoding mode is output to the image data decoder 230. In other words, the image data in a bit stream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, split information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the data according to an encoding method that generates the minimum encoding error.

Since encoding information about the coded depth and the encoding mode according to an embodiment may be assigned to a predetermined data unit from among a corresponding coding unit, a prediction unit, and a minimum unit, the image data and encoding information extractor 220 may extract the information about the coded depth and the encoding mode according to the predetermined data units. When the information about the coded depth and the encoding mode of a corresponding maximum coding unit is written according to the predetermined data units, the predetermined data units having the same information about the coded depth and the encoding mode may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse frequency transformation.

The image data decoder 230 may perform intra prediction or motion compensation according to a partition and a prediction mode of each coding unit, based on the information about the partition type and the prediction mode of the prediction unit of the coding unit according to coded depths.

Also, the image data decoder 230 may perform inverse frequency transformation according to each transformation unit in the coding unit, based on the information about a size of the transformation unit of the coding unit according to coded depths, in order to perform the inverse frequency transformation according to maximum coding units.

The image data decoder 230 may determine a coded depth of a current maximum coding unit by using split information according to depths. If the split information indicates that image data is no longer split in the current depth, the current depth is a coded depth. Accordingly, the image data decoder 230 may decode image data of a coding unit corresponding to the current depth in the current maximum coding unit by using the information about the partition type of the prediction unit, the prediction mode, and the size of the transformation unit for each coding unit corresponding to the coded depth.

In other words, data units containing the encoding information including the same split information may be gathered by observing the encoding information set for the predetermined data unit from among the coding unit, the prediction unit, and the minimum unit, and the gathered data units may be considered to be one data unit to be decoded by the image data decoder 230 in the same encoding mode.

The video decoding apparatus 200 according to an embodiment may obtain information about a coding unit that generates a minimum encoding error when encoding is recursively performed for each maximum coding unit, and may use the information to decode the current picture. In other words, the coding units having the tree structure determined to be the optimum coding units in each maximum coding unit may be decoded.

Accordingly, even if image data has a high resolution and an excessively large amount of data, the image data may be efficiently decoded and restored by using a size of a coding unit and an encoding mode, which are adaptively determined according to characteristics of an image, by using information about an optimum encoding mode received from an encoder.

A method of determining coding units having a tree structure, a prediction unit, and a transformation unit, according to an exemplary embodiment will now be explained with reference to FIGS. 3 through 13.

FIG. 3 is a diagram for explaining a concept of hierarchical coding units according to an exemplary embodiment.

A size of a coding unit may be expressed in width×height, and may be 64×64, 32×32, 16×16, and 8×8. A coding unit having a size of 64×64 may be split into partitions having sizes of 64×64, 64×32, 32×64, or 32×32, and a coding unit having a size of 32×32 may be split into partitions having sizes of 32×32, 32×16, 16×32, or 16×16, a coding unit having a size of 16×16 may be split into partitions having sizes of 16×16, 16×8, 8×16, or 8×8, and a coding unit having a size of 8×8 may be split into partitions having sizes of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having the higher resolution than the video data 330 may be selected to be 64.

Since the maximum depth of the video data 310 is 2, coding units 315 of the video data 310 may include a maximum coding unit having a long axis size of 64, and coding units having long axis sizes of 32 and 16 since depths are increased to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are increased to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are increased to 3 layers by splitting the maximum coding unit three times. As a depth increases, detailed information may be precisely expressed.

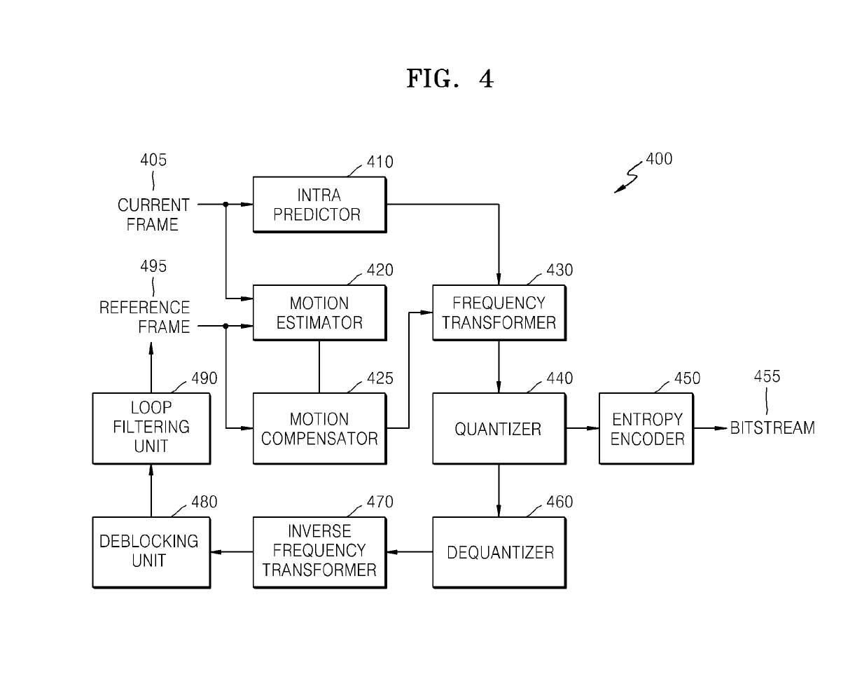

FIG. 4 is a block diagram illustrating an image encoder 400 based on coding units, according to an exemplary embodiment.

The image encoder 400 according to an embodiment performs operations of the coding unit determiner 120 of the video encoding apparatus 100 to encode image data. In other words, an intra predictor 410 performs intra prediction on coding units in an intra mode, from among a current frame 405, and a motion estimator 420 and a motion compensator 425 perform inter estimation and motion compensation on coding units in an inter mode by using the current frame 405, and a reference frame 495.

Data output from the intra predictor 410, the motion estimator 420, and the motion compensator 425 is output as a quantized transformation coefficient through a frequency transformer 430 and a quantizer 440. The quantized transformation coefficient is restored as data in a spatial domain through an inverse quantizer 460 and an inverse frequency transformer 470, and the restored data in the spatial domain is output as the reference frame 495 after being post-processed through a deblocking unit 480 and a loop filtering unit 490. The quantized transformation coefficient may be output as a bitstream 455 through an entropy encoder 450.

In order for the image encoder 400 to be applied in the video encoding apparatus 100 according to an embodiment, all elements of the image encoder 400, i.e., the intra predictor 410, the motion estimator 420, the motion compensator 425, the frequency transformer 430, the quantizer 440, the entropy encoder 450, the inverse quantizer 460, the inverse frequency transformer 470, the deblocking unit 480, and the loop filtering unit 490 have to perform operations based on each coding unit from among coding units having a tree structure in consideration of the maximum depth of each maximum coding unit.

Specifically, the intra predictor 410, the motion estimator 420, and the motion compensator 425 determine partitions and a prediction mode of each coding unit from among the coding units having a tree structure in consideration of the maximum size and the maximum depth of a current maximum coding unit, and the frequency transformer 430 determines a size of the transformation unit in each coding unit from among the coding units having the tree structure.

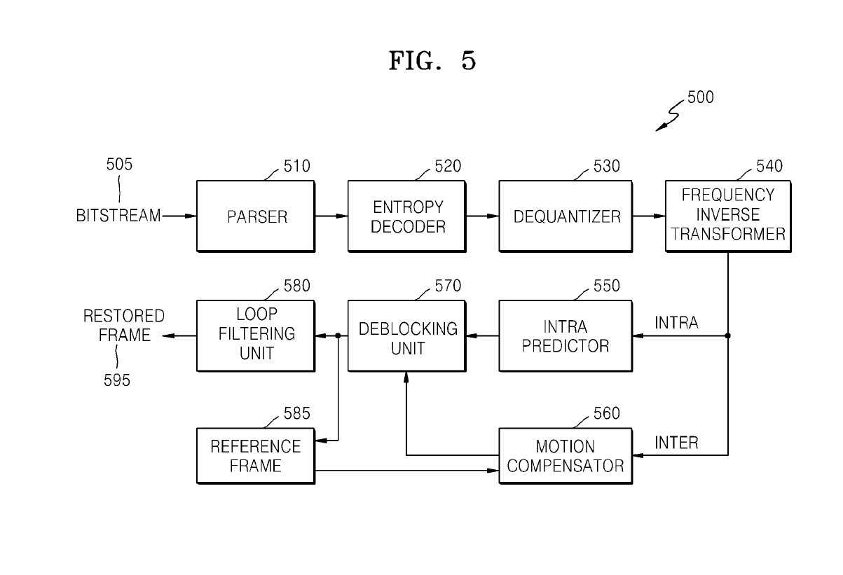

FIG. 5 is a block diagram illustrating an image decoder 500 based on coding units, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse frequency transformer 540.

An intra predictor 550 performs intra prediction on coding units in an intra mode with respect to the image data in the spatial domain, and a motion compensator 560 performs motion compensation on coding units in an inter mode by using a reference frame 585.

The data in the spatial domain, which passed through the intra predictor 550 and the motion compensator 560, may be output as a restored frame 595 after being post-processed through a deblocking unit 570 and a loop filtering unit 580. Also, the data, which is post-processed through the deblocking unit 570 and the loop filtering unit 580, may be output as the reference frame 585.

In order to decode the image data in the image data decoder 230 of the video decoding apparatus 200, the image decoder 500 according to an embodiment may perform operations that are performed after operations of the parser 510 are performed.

In order for the image decoder 500 to be applied in the video decoding apparatus 200 according to an embodiment, all elements of the image decoder 500, i.e., the parser 510, the entropy decoder 520, the inverse quantizer 530, the inverse frequency transformer 540, the intra predictor 550, the motion compensator 560, the deblocking unit 570, and the loop filtering unit 580 have to perform operations based on coding units having a tree structure for each maximum coding unit.

Specifically, the intra predictor 550 and the motion compensator 560 determine partitions and a prediction mode for each of the coding units having the tree structure, and the inverse frequency transformer 540 determines a size of a transformation unit for each coding unit.

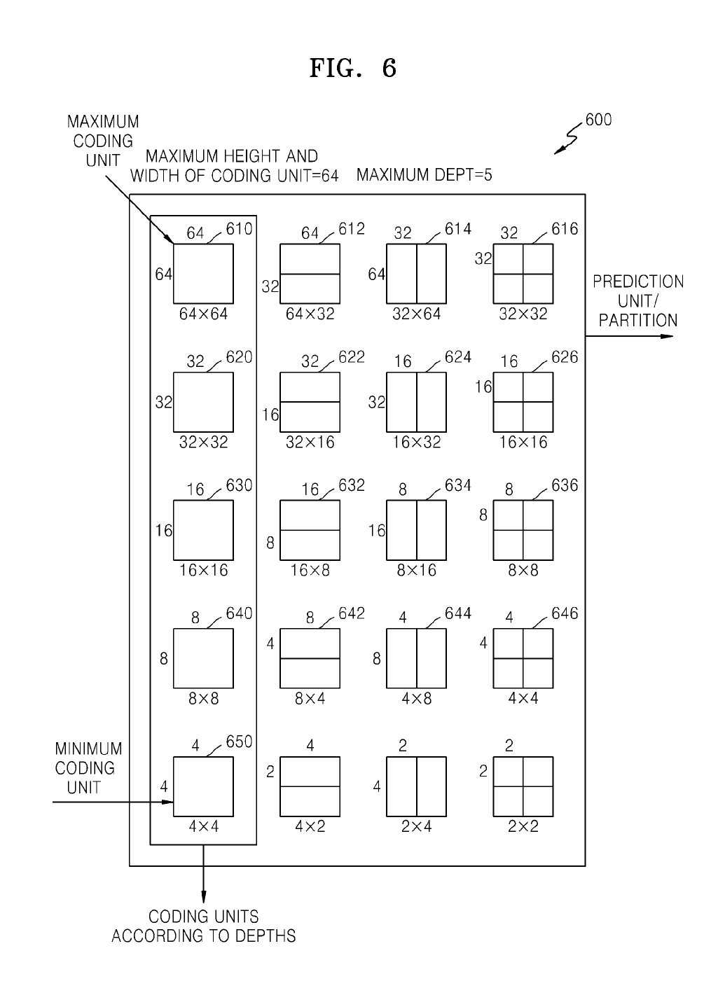

FIG. 6 is a diagram illustrating deeper coding units according to depths and partitions, according to an exemplary embodiment.

The video encoding apparatus 100 according to an embodiment and the video decoding apparatus 200 according to an embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units according to an embodiment, the maximum height and the maximum width of the coding units are each 64 and the maximum depth is 4. Since a depth increases along a vertical axis of the hierarchical structure 600 according to an embodiment, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, i.e., a height by width, is 64×64. The depth increases along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having the size of 4×4 and the depth of 4 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the coding unit 610, i.e. a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, i.e. a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, i.e. a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, i.e. a partition having a size of 8×8 included in the coding unit 640, partitions 642 having a size of 8×4, partitions 644 having a size of 4×8, and partitions 646 having a size of 4×4.

The coding unit 650 having the size of 4×4 and the depth of 4 is the minimum coding unit and a coding unit of the lowermost depth. A prediction unit of the coding unit 650 is only assigned to a partition having a size of 4×4.

In order to determine a coded depth the maximum coding unit 610, the coding unit determiner 120 of the video encoding apparatus 100 according to an embodiment has to perform encoding for coding units corresponding to each depth included in the maximum coding unit 610.

A number of deeper coding units according to depths including data in the same range and the same size increases as the depth increases. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 have to be each encoded.

In order to perform encoding for a current depth from among the depths, a representative error that is a least encoding error may be selected for the current depth by performing encoding for each prediction unit in the coding units corresponding to the current depth, along the horizontal axis of the hierarchical structure 600. Alternatively, a minimum encoding error may be searched for by comparing the representative encoding errors according to depths and performing encoding for each depth as the depth increases along the vertical axis of the hierarchical structure 600. A depth and a partition having a minimum encoding error in the coding unit 610 may be selected as the coded depth and a partition type of the coding unit 610.

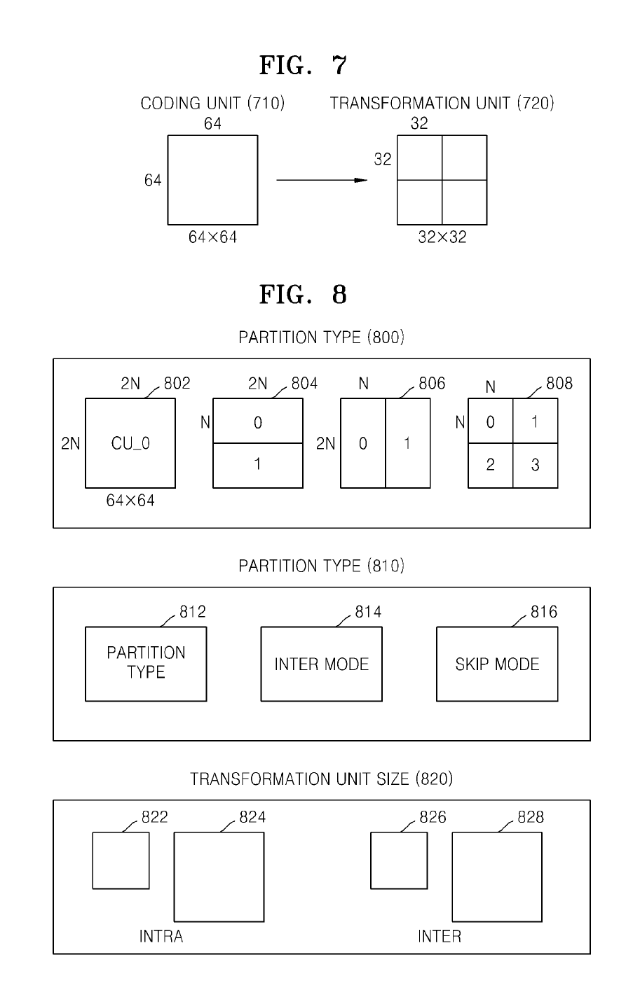

FIG. 7 is a diagram for explaining a relationship between a coding unit 710 and transformation units 720, according to an exemplary embodiment.

The video encoding apparatus 100 according to an embodiment or the video decoding apparatus 200 according to an embodiment encodes or decodes an image according to coding units having sizes less than or equal to a maximum coding unit for each maximum coding unit. Sizes of transformation units for frequency transformation during encoding may be selected based on data units that are not larger than each coding unit.

For example, in the video encoding apparatus 100 according to an embodiment or the video decoding apparatus 200 according to an embodiment, if a size of the current coding unit 710 is 64×64, frequency transformation may be performed by using the transformation units 720 having sizes of 32×32.

Also, data of the coding unit 710 having the size of 64×64 may be encoded by performing the frequency transformation on each of the transformation units having the sizes of 32×32, 16×16, 8×8, and 4×4, which are smaller than 64×64, and then a transformation unit having a least coding error may be selected.

FIG. 8 is a diagram for explaining encoding information of coding units corresponding to a coded depth, according to an exemplary embodiment.

The output unit 130 of the video encoding apparatus 100 according to an embodiment may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type of the current coding unit is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, i.e., an intra mode 812, an inter mode 814, or a skip mode 816.

Also, the information 820 indicates a transformation unit to be based on when frequency transformation is performed on a current coding unit. For example, the transformation unit may be any one of a first intra transformation unit 822, a second intra transformation unit 824, a first inter transformation unit 826, and a second intra transformation unit 828.

The image data and encoding information extractor 220 of the video decoding apparatus 200 according to an embodiment may extract and use the information 800, 810, and 820 for decoding, according to each deeper coding unit

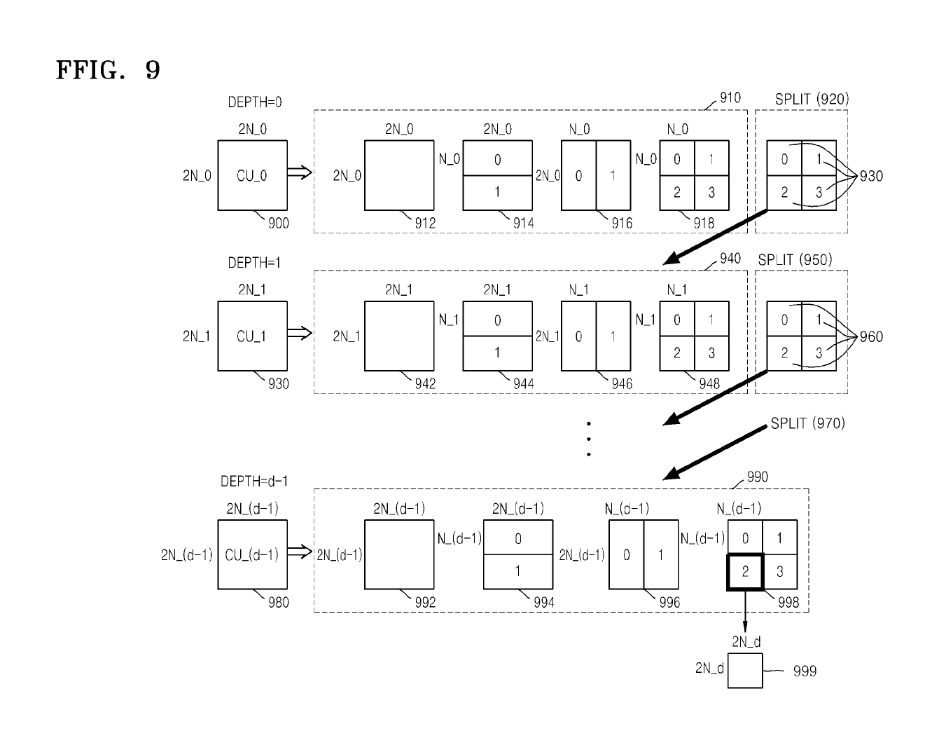

FIG. 9 is a diagram illustrating deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having an arbitrary shape, and partitions having a geometrical shape.

Prediction encoding has to be repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2N_{—}0×N_{—}0, and N_{—}0×N_{—}0. The prediction encoding in a skip mode may be performed only on the partition having the size of 2N_{—}0×2N_{—}0.

If an encoding error is smallest in one of the partition types 912 through 916 having the sizes of 2N_{—}0×2N_{—}0, 2N_{—}0×N_{—}0, and N_{—}0×2N_{—}0, the prediction unit 910 may not be split to a lower depth.

If the encoding error is the least in the partition type 918 having the size of N_{—}0×N_{—}0, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the least in the partition type 948 having the size of N_{—}1×N_{—}1, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, split operation according to each depth may be performed until a depth becomes d−1, and split information may be encoded until a depth is one of 0 to d−2. In other words, when encoding is performed until the depth is d−1 after a coding unit corresponding to a depth of d−2 is split in operation 970, a prediction unit 990 for prediction encoding a coding unit 980 having a depth of d−1 and a size of 2N_(d−1)×2N_(d−1) may include partitions of a partition type 992 having a size of 2N_(d−1)×2N_(d−1), a partition type 994 having a size of 2N_(d−1)×N_(d−1), a partition type 996 having a size of N_(d−1)×2N_(d−1), and a partition type 998 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 having the size of N_(d−1)×N_(d−1) has the least encoding error, since a maximum depth is d, a coding unit CU_(d−1) having a depth of d−1 is no longer split to a lower depth, and a coded depth for the coding units constituting a current maximum coding unit 900 is determined to be d−1 and a partition type of the current maximum coding unit 900 may be determined to be N_(d−1)×N_(d−1). Also, since the maximum depth is d, split information for a minimum coding unit 952 having a depth of d−1 is not set.

A data unit 999 may be referred to as a ‘minimum unit’ for the current maximum coding unit. A minimum unit according to an embodiment may be a rectangular data unit obtained by splitting a minimum coding unit having a lowermost coded depth by 4. By performing the encoding repeatedly, the video encoding apparatus 100 according to an embodiment may select a depth having a least encoding error by comparing encoding errors according to depths of the coding unit 900 to determine a coded depth, and may set a corresponding partition type and a prediction mode as an encoding mode of the coded depth.

As such, minimum encoding errors according to depths are compared in all of the depths of 1 through d, and a depth having a least encoding error may be determined as a coded depth. The coded depth, the partition type of the prediction unit, and the prediction mode may be encoded and transmitted as information about an encoding mode. Also, since a coding unit has to be split from a depth of 0 to a coded depth, only split information of the coded depth is set to 0, and split information of depths excluding the coded depth is set to 1.

The image data and encoding information extractor 220 of the video decoding apparatus 200 according to an embodiment may extract and use the information about the coded depth and the prediction unit of the coding unit 900 to decode the coding unit 912. The video decoding apparatus 200 according to an embodiment may determine a depth, in which split information is 0, as a coded depth by using split information according to depths, and may use information about an encoding mode of the corresponding depth for decoding.

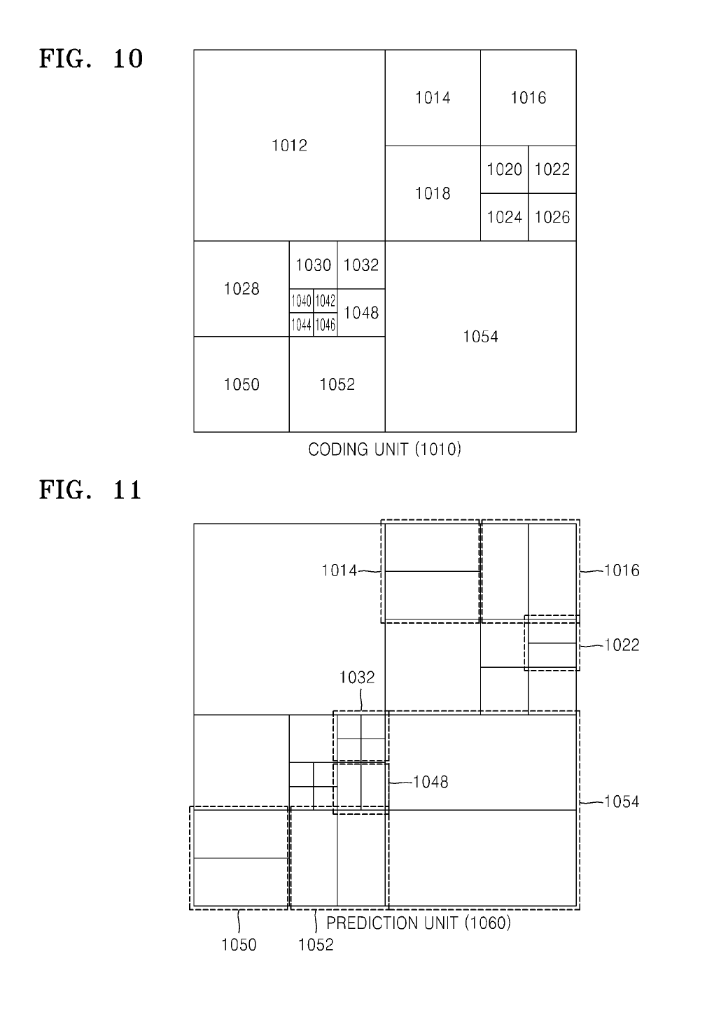

FIGS. 10 through 12 are diagrams for explaining a relationship between coding units 1010, prediction units 1060, and frequency transformation units 1070, according to an exemplary embodiment.

The coding units 1010 are coding units corresponding to coded depths determined by the video encoding apparatus 100 according to an embodiment, in a maximum coding unit. The prediction units 1060 are partitions of prediction units of each of the coding units 1010, and the transformation units 1070 are transformation units of each of the coding units 1010.

When a depth of the maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some partitions 1014, 1016, 1022, 1032, 1048, 1050, 1052, and 1054 are obtained by splitting the coding units. In other words, partition types in the partitions 1014, 1022, 1050, and 1054 have a size of 2N×N, partition types in the partitions 1016, 1048, and 1052 have a size of N×2N, and a partition type of the partition 1032 has a size of N×N. Prediction units and partitions of the coding units 1010 are smaller than or equal to each coding unit.

Frequency transformation or inverse frequency transformation is performed on image data of the transformation unit 1052 in the transformation units 1070 in a data unit that is smaller than the transformation unit 1052. Also, the transformation units 1014, 1016, 1022, 1032, 1048, 1050, and 1052 in the transformation units 1070 are different from those in the prediction units 1060 in terms of sizes and shapes. In other words, the video encoding apparatus 100 according to an embodiment and the video decoding apparatus 200 according to an embodiment may perform intra prediction/motion estimation/motion compensation, and frequency transformation/inverse frequency transformation individually on a data unit in the same coding unit.

Accordingly, encoding is recursively performed on each of coding units having a hierarchical structure in each region of a maximum coding unit to determine an optimum coding unit, and thus coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to an embodiment and the video decoding apparatus 200 according to an embodiment.

TABLE 1

| Split Information 0 | | | | | |
|---|---|---|---|---|---|
| (Encoding on Coding Unit having Size of 2N × 2N and Current Depth of d) | | | | | |
| | Partition Type | | Size of Transformation Unit | | |
| Prediction | Symmetrical | Asymmetrical | Split Information 0 | Split Information 1 of | Split |
| Mode | Partition Type | Partition Type | of Transformation Unit | Transformation Unit | Information 1 |
| Intra | 2N × 2N | 2N × nU | 2N × 2N | N × N | Repeatedly |
| Inter | 2N × N | 2N × nD | | (Symmetrical | Encode |
| Skip (Only | N × 2N | nL × 2N | | Partition Type) | Coding Units |
| 2N × 2N) | N × N | nR × 2N | | N/2 × N/2 | having Lower |
| | | | | (Asymmetrical | Depth of d + 1 |
| | | | | Partition Type) | |

The output unit 130 of the video encoding apparatus 100 according to an embodiment may output the encoding information about the coding units having a tree structure, and the image data and encoding information extractor 220 of the video decoding apparatus 200 according to an embodiment may extract the encoding information about the coding units having the tree structure from a received bitstream.

Split information indicates whether a current coding unit is split into coding units of a lower depth. If split information of a current depth d is 0, a depth, in which a current coding unit is no longer split to a lower depth, is a coded depth, and thus information about a partition type, prediction mode, and a size of a transformation unit may be defined for the coded depth. If the current coding unit is further split according to the split information, encoding has to be independently performed on four split coding units of a lower depth.

A prediction mode may be one of an intra mode, an inter mode, and a skip mode. The intra mode and the inter mode may be defined in all partition types, and the skip mode may be defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1.

The size of the transformation unit may be set to be two types in the intra mode and two types in the inter mode. In other words, if split information of the transformation unit is 0, the size of the transformation unit is set to 2N×2N, which is the size of the current coding unit. If split information of the transformation unit is 1, the transformation units may be set by splitting the current coding unit. Also, if a partition type of the current coding unit having the size of 2N×2N is a symmetrical partition type, a size of a transformation unit may be set to N×N, and if the partition type of the current coding unit is an asymmetrical partition type, the size of the transformation unit may be set to N/2×N/2.

The encoding information about coding units having a tree structure may be assigned to at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit in the deeper coding units are searched for using encoded information of the data units, and the searched adjacent coding units may be referred to for predicting the current coding unit.

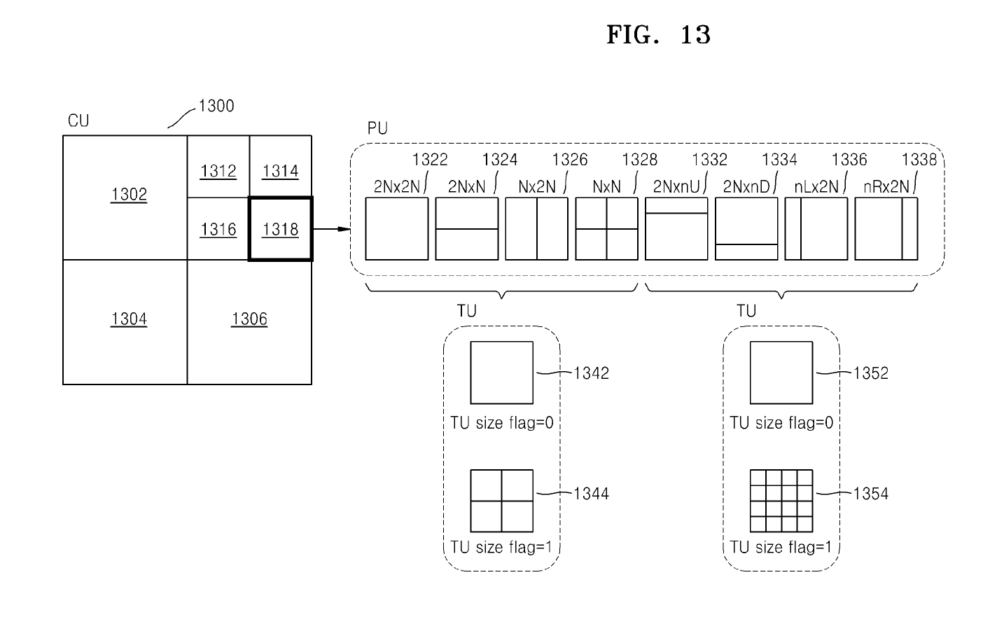

FIG. 13 is a diagram for explaining a relationship between a coding unit, a prediction unit, and a transformation unit, according to the encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

When the information about the partition type is set to a symmetrical partition type, i.e. the partition type 1322, 1324, 1326, or 1328, a transformation unit 1342 having a size of 2N×2N may be set if split information (TU size flag) of a transformation unit is 0, and a transformation unit 1344 having a size of N×N may be set if a TU size flag is 1.

When the information about the partition type is set to an asymmetrical partition type, i.e., the partition type 1332, 1334, 1336, or 1338, a transformation unit 1352 having a size of 2N×2N may be set if a TU size flag is 0, and a transformation unit 1354 having a size of N/2×N/2 may be set if a TU size flag is 1.

A process performed by the entropy encoder 450 of the image encoder 400 according to an exemplary embodiment of FIG. 4 and the entropy decoder 520 of the image decoder 500 of FIG. 5 to encode and decode a unified syntax for parallel processing will now be explained in detail.

FIG. 14 is a reference diagram for explaining a concept of parallel processing of video data units, according to an exemplary embodiment.

Referring to FIG. 14, when it is assumed that data units D1 through D4 of a bitstream 1410 are not dependent on one another and may be independently encoded and decoded, the data units D1 through D4 may be assigned to multiple cores 1421 through 1424 of a central processing unit (CPU) or a graphics processing unit (GPU) 1420 that is provided in a video encoding/decoding apparatus and may be parallel processed. For such parallel processing, information for determining whether each of the data units D1 through D4 is a data unit that may be parallel processed (hereinafter, referred to as parallel processable data unit) is necessary.

To this end, according to an exemplary embodiment, a flag indicating whether parallel processing of a predetermined data unit is possible is set. According to an exemplary embodiment, the existence of a flag indicating whether parallel processing is possible defined at a lower level is determined by a flag indicating whether parallel processing is possible defined at an upper level. In other words, the flat indicating whether parallel processing is possible of the lower level may be set only when the flag indicating whether parallel processing is possible of the upper level is set to 1. The flag indicating whether parallel processing is possible of the lower level may be skipped when the flag indicating whether parallel processing is possible of the upper level is set to 0. A process of setting a flag indicating whether parallel processing of each data unit is possible will be explained below in detail.

FIG. 15 is a block diagram illustrating an entropy encoding apparatus 1500 according to an exemplary embodiment. The entropy encoding apparatus 1500 of FIG. 15 corresponds to the entropy encoder 450 of FIG. 4.

Referring to FIG. 15, the entropy encoding apparatus 1500 includes a parallel processing determiner 1510 and a parallel processing information output unit 1520.

The parallel processing determiner 1510 obtains encoded data of a first data unit that constitutes a video and a second data unit whose level is lower than a level of the first data unit, and determines whether data that may be parallel processed (hereinafter, referred to as parallel processable data) is included in the first data unit and the second data unit.

The parallel processing information output unit 1520 encodes and outputs to a first data unit header a first data unit parallel processing flag indicating whether parallel processable data is included in the first data unit. If parallel processable data is included in the first data unit and parallel processable data is included in the second data unit as well, the parallel processing information output unit 1520 encodes and outputs to a second data unit header a second data unit parallel processing flag indicating whether parallel processable data is included in the second data unit. If parallel processable data is not included in the first data unit, the parallel processing information output unit 1520 may set the first data unit parallel processing flag to 0 and may not encode and may skip the second data unit parallel processing flag.

Parallel processable data units used in exemplary embodiments will now be explained in detail.

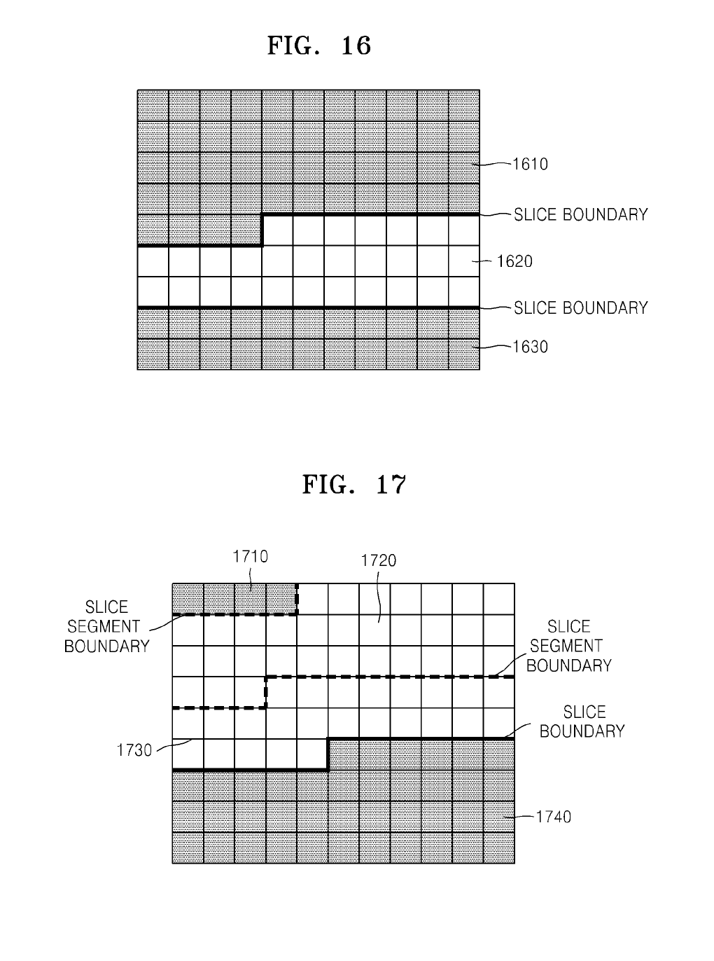

FIG. 16 is a reference diagram for explaining a slice unit according to an exemplary embodiment.

Referring to FIG. 16, one picture may be divided into slices 1610, 1620, and 1630. One slice may include one or more maximum coding units or Largest coding unit (LCU) that are continuous according to a raster scan order. In FIG. 16, one picture is divided into three slices 1610, 1620, and 1630 by slice boundaries. Also, it is assumed that the slices 1610 and 1630 hatched in FIG. 16 are slices that have no dependence on other slices and may be independently processed. In this case, the parallel processing information output unit 1520 encodes and outputs to a header of a picture including slices, that is, to a picture parameter set (PPS), a flag slice_enabled_flag indicating whether a parallel processable slice exists. That is, when a parallel processable slice exists, the parallel processing information output unit 1520 sets the flag slice_enabled_flag to 1 and adds the flag slice_enabled_flag to the PPS. In addition, when the flag slice_enabled_flag is set to 1, the parallel processing information output unit 1520 may add a syntax num_of_slice indicating a number of parallel processable slices to a slice header or the PPS.

A flag indicating whether each slice is a parallel processable slice may be included in a header of the three slices 1610, 1620, and 1630. Also, when a parallel processable slice exists in a current picture, the parallel processing information output unit 1520 may set a flag parallel_processing_param_enabled_pps_flag indicating whether parallel processable data exists in the PPS of the current picture to 1 and may output the flag parallel_processing_param_enabled_pps_flag. Also, when a parallel processable slice exists, the parallel processing information output unit 1520 may set a flag parallel_processing_param_enabled_sps_flag indicating whether parallel processable data exists in a sequence to 1 and may output the flag parallel_processing_param_enabled_sps_flag to a header of a sequence that is an uppermost data unit, that is to, a sequence parameter set (SPS).

FIG. 17 is a reference diagram for explaining a slice unit according to another exemplary embodiment.

Referring to FIG. 17, it is assumed that one picture is divided into two slices by a slice boundary. Also, it is assumed that an upper slice is divided into three slice segments 1710, 1720, and 1730 by slice segment boundaries. Also, it is assumed that a slice 1740 and the slice segment 1710 hatched in FIG. 17 are data units that may be independently processed without referring to other slices or other slice segments. In this case, the parallel processing information output unit 1520 encodes and outputs to the PPS the flag slice_enabled_flag indicating whether a parallel processable slice exists, and encodes and outputs a flag dependent_slice_segments_enabled_flag indicating whether segments obtained by dividing a slice, that is, slice segments, are used. Also, the parallel processing information output unit 1520 sets the flag parallel_processing_param_enabled_pps_flag indicating whether parallel processable data exists in a current picture to 1 and outputs the flag parallel_processing_param_enabled_pps_flag to the PPS of the current picture. Also, the parallel processing information output unit 1520 sets the flag parallel_processing_param_enabled_sps_flag indicating whether parallel processable data exists in a sequence to 1 and may output the flag parallel_processing_param_enabled_sps_flag to the SPS.

The flag slice_enabled_flag that is a syntax indicating whether a slice is used and the syntax num_of_slice that is information about a number of slices may be included in a header of a slice data unit or an upper data unit of the slice data unit such as the SPS, the PPS, an adaptive parameter set (APS), or a slice header.

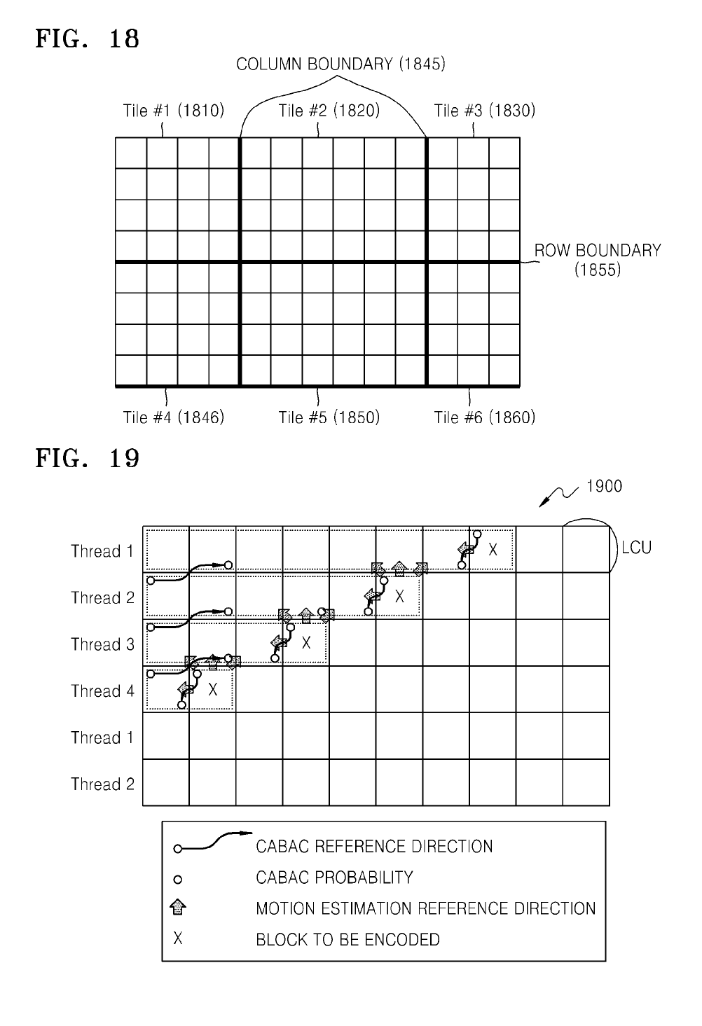

FIG. 18 is a reference diagram for explaining a tile unit according to an exemplary embodiment.

Referring to FIG. 18, one picture may be divided into a plurality of tiles 1810, 1820, 1830, 1840, 1850, and 1860. Each tile is a set of maximum coding units LCUs that are separated by a column boundary 1845 and a row boundary 1855, and refers to an independent data processing unit whose motion estimation or context prediction exceeding the column boundary 1845 or the row boundary 1855 is impossible. That is, each tile is an independent data processing unit that does not refer to information of other tiles and may be parallel processed. When a current picture may be divided into tiles, the parallel processing information output unit 1520 sets a flag tile_enabled_flag indicating whether a parallel processable tile exists to 1 and outputs the flag tile_enabled_flag to the PPS. Also, the parallel processing information output unit 1520 sets the flag parallel_processing_param_enabled_pps_flag indicating whether parallel processable data exists in the current picture to 1 and outputs the flag parallel_processing_param_enabled_pps_flag to the PPS. Also, the parallel processing information output unit 1520 sets the flag parallel_processing_param_enabled_sps_flag indicating whether parallel processable data exists in a sequence to 1 and outputs the flag parallel_processing_param_enabled_sps_flag to the SPS.

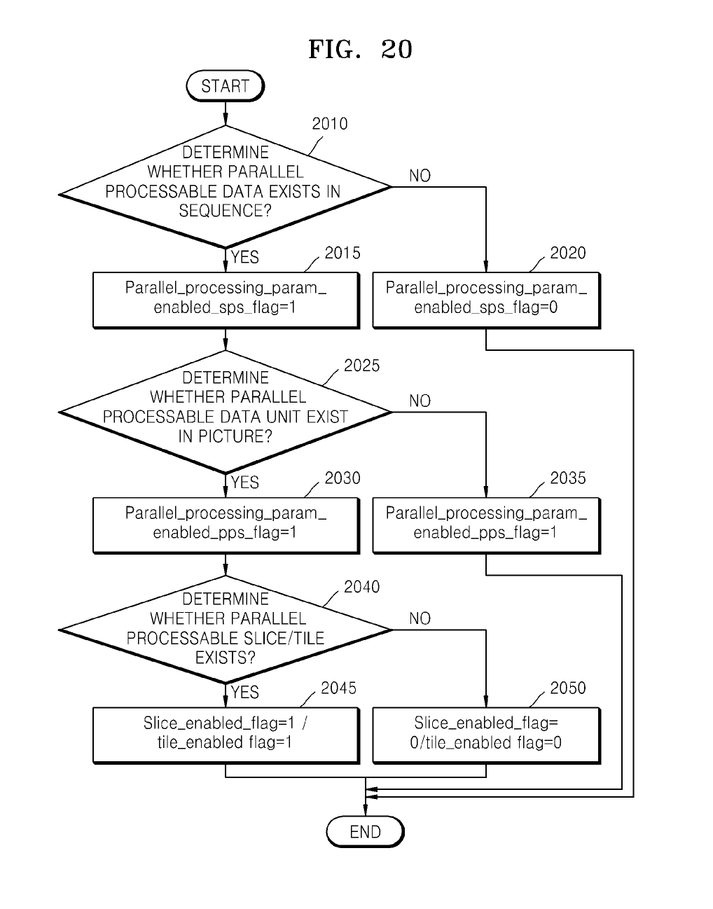

FIG. 19 is a reference diagram 1900 for explaining wavefront parallel processing (WPP) according to an exemplary embodiment.

WPP includes a process of resetting context-adaptive binary arithmetic coding (CABAC) probabilities of a first maximum coding unit LCU of each row to a probability obtained by processing a second maximum coding unit of an upper row, for the purpose of parallel encoding/decoding. For example, referring to FIG. 19, a CABAC probability of a first maximum coding unit 1920 of a second row, that is, thread 2 for entropy encoding/decoding may be reset by using a CABAC probability 1911 obtained by processing a second maximum coding unit 1910 of a first row, that is, thread 1. Also, according to WPP, since first maximum coding units of each row are processed after a second maximum coding unit of an upper row is completely processed, maximum coding units of each row may obtain motion estimation information, for example, predictive motion vector information, by using maximum coding units of an upper row. Accordingly, first through fourth rows, that is, thread 1 through thread 4, of FIG. 19 may be parallel processed at a time when a second maximum coding unit of an upper row is completed.

When a WPP method is used to encode a current picture, the parallel processing information output unit 1520 sets a flag cabac_istate_reset_flag 2230 indicating whether WPP is used to 1 and outputs the flag cabac_istate_reset_flag 2230 to the PPS. Also, the parallel processing information output unit 1520 sets the flag parallel_processing_param_enabled_pps_flag indicating whether parallel processable data exists in the current picture to 1 and outputs the flag parallel_processing_param_enabled_pps_flag to the PPS. Also, the parallel processing information output unit 1520 sets the flag parallel_processing_param_enabled_sps_flag indicating whether parallel processable data exists in a sequence to 1 and outputs the flag parallel_processing_param_enabled_sps_flag to the SPS.

FIG. 20 is a flowchart illustrating a process performed by the parallel processing information output unit 1520 to set a flag indicating whether parallel processable data exists in each data unit, according to an exemplary embodiment.

Referring to FIG. 20, in operation 2010, the parallel processing determiner 1510 determines whether a parallel processable data unit exists in a current sequence. As described above, when there exists data that is encoded by using an independent slice, by using a tile, or a WPP method, in the current sequence, in operation 2015, the parallel processing information output unit 1520 sets the flag parallel_processing_param_enabled_sps_flag indicating whether parallel processable data exists in a sequence to 1 and outputs the flag parallel_processing_param_enabled_sps_flag to the SPS. When it is determined in operation 2010 that there does not exist a parallel processable data unit in the current sequence, in operation 2020, the parallel processing information output unit 1520 sets the flag parallel_processing_param_enabled_sps_flag to 0, and may not set and may skip a flag indicating whether parallel processable data exists in a lower data unit.

In operation 2025, the parallel processing determiner 1510 determines whether parallel processable data exists in each of a plurality of pictures existing in the sequence. In operation 2030, only for a picture that is determined to have parallel processable data therein, the parallel processing information output unit 1520 sets the flag parallel_processing_param_enabled_pps_flag indicating whether parallel processing data exists in the current picture to 1 and outputs the flag parallel_processing_param_enabled_pps_flag to the PPS of the corresponding picture. In operation 2035, when there does not exist parallel processable data in the current picture, the parallel processing information output unit 1520 sets the flag parallel_processing_param_enabled_pps_flag indicating whether parallel processable data exists in the current picture to 0 and outputs the flag parallel_processing_param_enabled_pps_flag to the PPS, and does not set and skips a flag for a lower data unit.

In operation 2040, for the picture that is determined to have parallel processable data therein, the parallel processing determiner 1510 determines whether a parallel processable slice or tile exists. In operation 2045, when a parallel processable slice or tile exists, the parallel processing information output unit 1520 sets the flag slice_enabled_flag or tile_enabled_flag to 1. In operation 2050, when there does not exist a parallel processable slice or tile, the parallel processing information output unit 1520 sets the flag slice_enabled_flag or tile enabled_flag to 0 and outputs the flag slice_enabled_flag or tile enabled_flag.

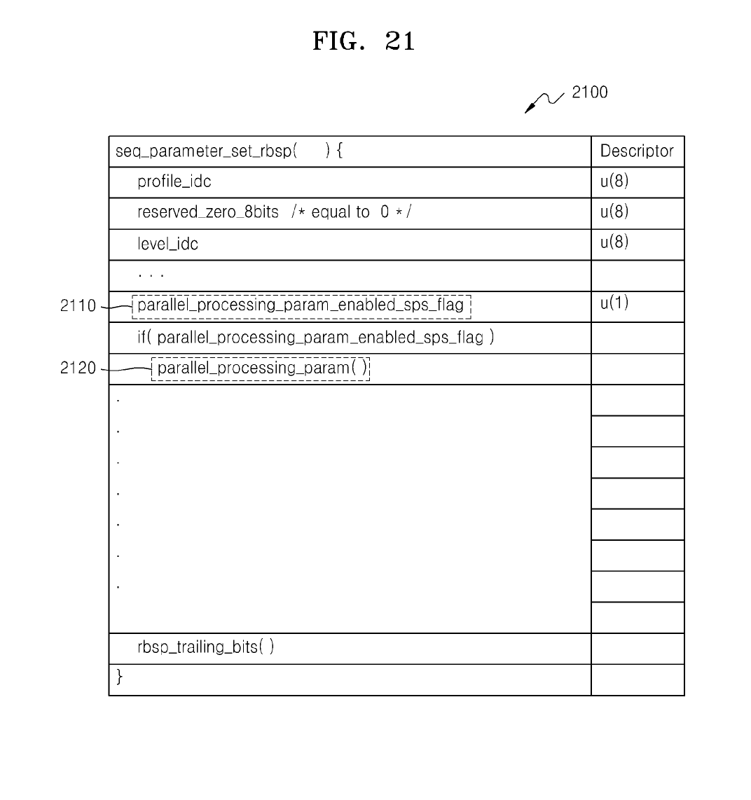

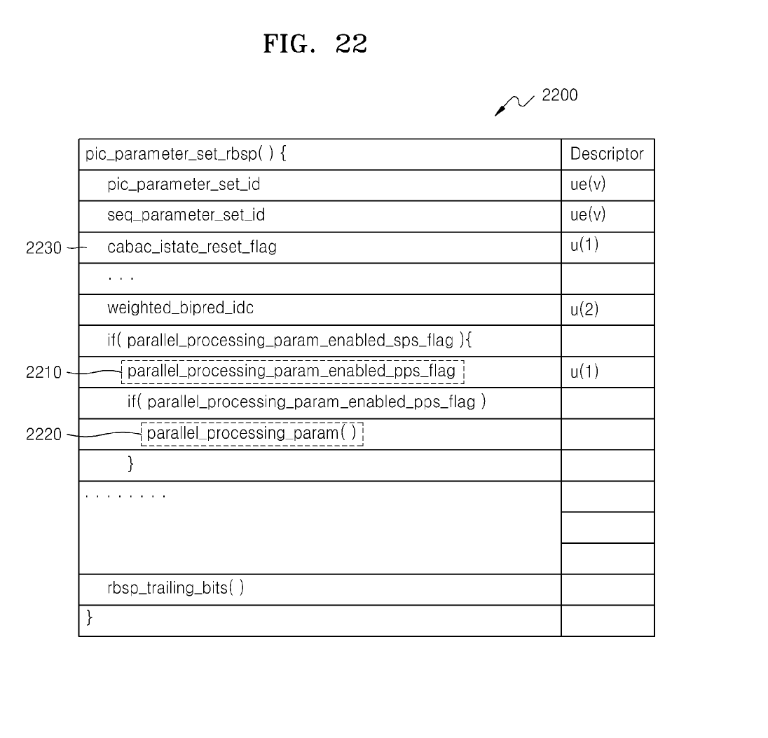

FIG. 21 is a diagram illustrating an SPS 2100 according to an exemplary embodiment.

Referring to FIG. 21, a flag parallel_processing_param_enabled_sps_flag 2110 indicating whether a parallel processable data unit exists in a sequence is included in the SPS 2100. When the flag parallel_processing_param_enabled_sps_flag is 1, it is indicated that a parallel processable data unit exists in the corresponding sequence, and when the flag parallel_processing_param_enabled_sps_flag is 0, it is indicated that a parallel processable data unit does not exist in the corresponding sequence. When the flag parallel_processing_param_enabled_sps_flag is 1, parallel processing information parallel_processing_param( ) 2120 may be obtained at a sequence level. The parallel processing information parallel_processing_param( ) 2120 may include additional information related to a slice, WPP, and a tile.

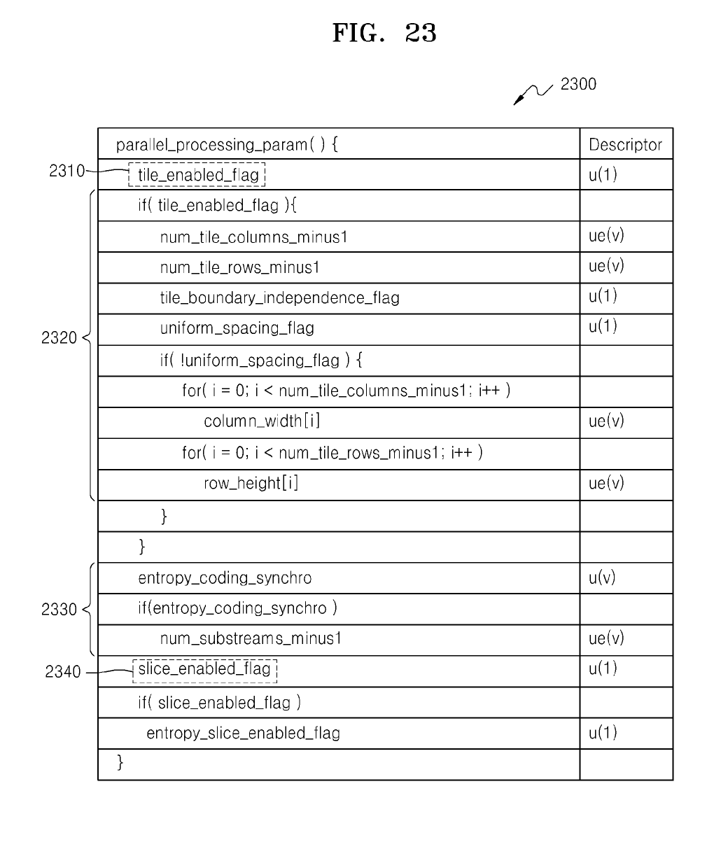

FIG. 22 is a diagram illustrating a PPS 2200 according to an exemplary embodiment.

Referring to FIG. 22, a flag parallel_processing_param_enabled_pps_flag 2210 indicating whether a parallel processable data unit exists in a picture is included in the PPS 2200. When the flag parallel_processing_param_enabled_pps_flag is 1, it is indicated that a parallel processable data unit exists in the corresponding picture, and when the flag parallel_processing_param_enabled_pps_flag is 0, it is indicated that a parallel processable data unit does not exist in the corresponding picture. When the flag parallel_processing_param_enabled_pps_flag is 1, parallel processing information parallel_processing_param( ) 2220 may be obtained at a picture level. The parallel processing information parallel_processing_param( ) 2220 may include additional information related to a slice, WPP, and a tile. The parallel processing information parallel_processing_param( ) 2220 that is obtained at the picture level replaces the parallel processing information parallel_processing_param( ) 2120 that is obtained at the sequence level. In other words, the parallel processing information parallel_processing_param( ) 2220 that is obtained at the picture level that is a lower level has a higher priority than the parallel processing information parallel_processing_param( ) 2120 that is obtained at the sequence level. A flag cabac_istate_reset_flag 2230 indicating whether a current picture uses a WPP method may be included in the PPS 2200.

FIG. 23 is a diagram illustrating parallel processing information parallel_processing_param( ) 2300 according to an exemplary embodiment.

Referring to FIG. 23, the parallel processing information parallel_processing_param( ) 2300 may include a flag tile_enabled_flag 2310 indicating whether a tile is used, a syntax 2320 of additional information related to a tile, a syntax 2330 of additional information related to WPP, and a flag slice_enabled_flag 2340 indicating whether a parallel processable slice is used. When the flag tile_enabled_flag is 1, it is indicated that a picture or a sequence is divided into tiles and may be independently processed. When the flag slice_enabled_flag is 1, it is indicated that a slice that may be independently processed is used in a picture or a sequence. As described above, parallel processing information may be obtained at both a sequence level that is an upper data unit level and a picture level that is a lower data unit level. When parallel processing information is separately defined in a picture in a sequence, parallel processing information that is defined at a picture level that is a lower level has a higher priority than parallel processing information that is obtained at a sequence level. That is, when the parallel processing information parallel_processing_param( ) that is defined at a sequence level that is an upper level and the parallel processing information parallel_processing_param( ) that is defined at a picture level that is a lower level are different from each other, the parallel processing information parallel_processing_param( ) that is defined at the picture level that is a lower level is actually used with a higher priority.

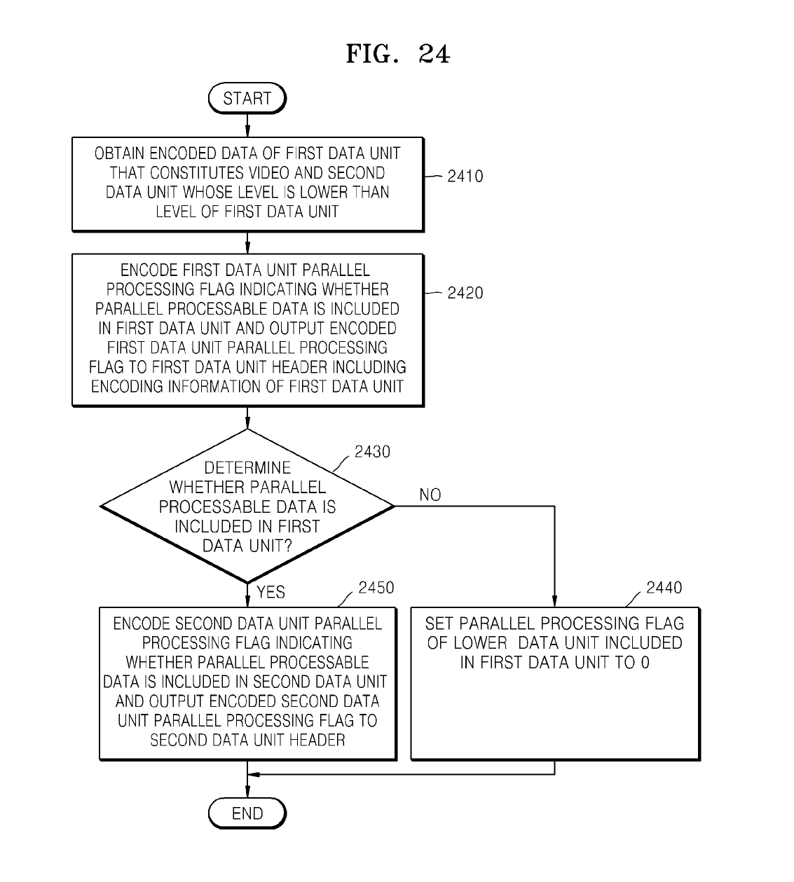

FIG. 24 is a flowchart illustrating a video encoding method according to an exemplary embodiment.

Referring to FIG. 24, in operation 2410, the parallel processing determiner 1510 obtains encoded data of a first data unit that constitutes a video and a second data unit whose level is lower than a level of the first data unit. Next, the parallel processing determiner 1510 determines whether a parallel processable data unit exists in the first data unit and whether a parallel processable data unit exists in the second data unit that is included in the first data unit.

In operation 2420, the parallel processing information output unit 1520 encodes a first data unit parallel processing flag indicating whether parallel processable data is included in the first data unit and outputs the encoded first data unit parallel processing flag to a first data unit header including encoding information of the first data unit. As described above, when data that is encoded by using an independent slice, by using a tile, or by using a WPP method exists in a current sequence, the parallel processing information output unit 1520 may set the flag parallel_processing_param_enabled_sps_flag indicating whether parallel processable data exists in a sequence to 1 and output the flag parallel_processing_param_enabled_sps_flag to the SPS.

When parallel processable data is not included in the first data unit (operation 2430—NO), a process of setting a second data unit parallel processing flag is skipped. In this case, the skipped second data unit parallel processing flag may be set to 0 (operation 2440).

Only when parallel processable data is included in the first data unit (operation 2430—YES), a parallel processing flag indicating whether parallel processable data is included in the second data unit whose level is lower than that of the first data unit is set. That is, when parallel processable data is included in the first data unit, the parallel processing information output unit 1520 encodes and outputs to a second data unit header a second data unit parallel processing flag indicating whether parallel processable data is included in the second data unit (operation 2450). As described above, for a picture that is determined to have parallel processable data therein, the parallel processing information output unit 1520 sets the flag parallel_processing_param_enabled_pps_flag indicating whether parallel processable data exists in a current picture to 1 and outputs the flag parallel_processing_param_enabled_pps_flag to the PPS of the corresponding picture.

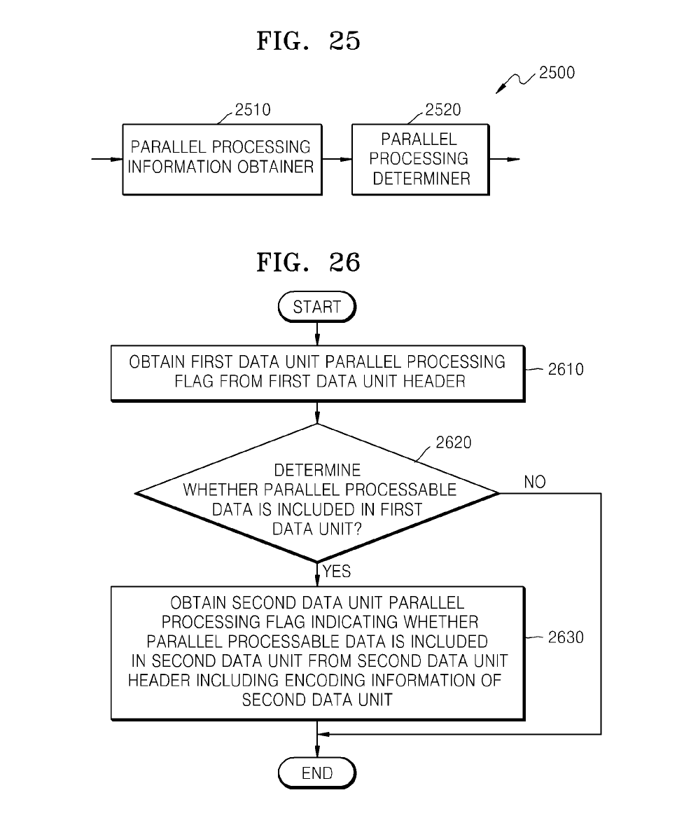

FIG. 25 is a block diagram illustrating an entropy decoding apparatus 2500 according to an exemplary embodiment. FIG. 26 is a flowchart illustrating a video decoding method according to an exemplary embodiment. The entropy decoding apparatus 2500 of FIG. 25 corresponds to the entropy decoder 520 of FIG. 5.

Referring to FIGS. 25 and 26, in operation 2610, a parallel processing information obtainer 2510 obtains a first data unit parallel processing flag indicating whether parallel processable data is included in a first data unit from a first data unit header including encoding information of the first data unit that constitutes a video included in a bitstream. When it is determined based on the first data unit parallel processing flag that parallel processable data is included in the first data unit in operation 2620, the parallel processing information obtainer 2510 obtains a second data unit parallel processing flag indicating whether parallel processable data is included in a second data unit from a second data unit header including encoding information of the second data unit whose level is lower than a level of the first data unit in operation 2630. A parallel processing determiner 2520 may determine whether each data unit may be parallel processed based on each obtained data unit parallel processing flag, and may enable parallel processing to be performed by assigning parallel processable data to a plurality of image processing cores (not shown).

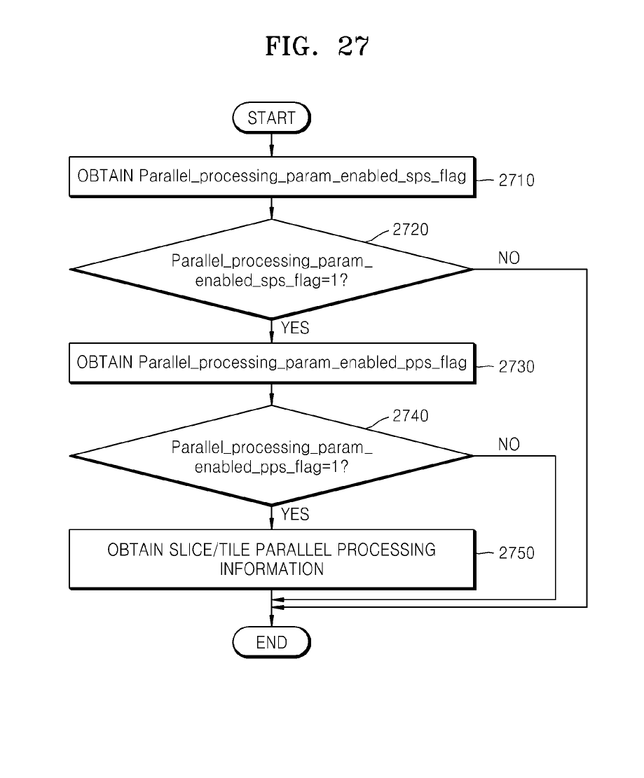

FIG. 27 is a detailed flowchart illustrating a video decoding method for parallel processing, according to an exemplary embodiment.

Referring to FIG. 27, in operation 2710, the parallel processing information obtainer 2510 obtains the flap parallel_processing_param_enabled_sps_flag indicating whether parallel processable data exists in a current sequence from the SPS of a bitstream.

When the parallel processing determiner 2520 determines that the flag parallel_processing_param_enabled_sps_flag is 1, that is, when the parallel processing determiner 2520 determines that a parallel processable data unit exists in the current sequence in operation 2720, the parallel processing information obtainer 2510 obtains the flag parallel_processing_param_enabled_pps_flag indicating whether parallel processable data exists in each of a plurality of pictures that exist in a sequence in operation 2730.

In operation 2740, the parallel processing determiner 2520 determines whether the flag parallel_processing_param_enabled_pps_flag is 1, that is, whether a parallel processable data unit exists. In operation 2750, for a picture that is determined to have a parallel processable data unit therein, the parallel processing information obtainer 2510 obtains the flag, that is, slice_enabled_flag or tile_enabled_flag, indicating whether parallel processable data using a slice or a tile exists. The parallel processing determiner 2520 determines whether each data unit may be parallel processed based on each obtained flag and enables parallel processing to be performed by assigning a parallel processable data unit to a plurality of cores (not shown)

The afore-described exemplary embodiments may be implemented as an executable program, and may be executed by a general-purpose digital computer or processor that runs the program by using a computer-readable recording medium. Examples of the computer-readable medium include storage media such as magnetic storage media (e.g., read only memories (ROMs), floppy discs, or hard discs), optically readable media (e.g., compact disk-read only memories (CD-ROMs), or digital versatile disks (DVDs)), etc.

While exemplary embodiments have been particularly shown and explained with reference to the drawings, it will be understood by those of ordinary skill in the art that various changes in form and details may be made therein without departing from the spirit and scope of the inventive concept as defined by the appended claims. The exemplary embodiments should be considered in descriptive sense only and not for purposes of limitation. Therefore, the inventive concept is defined not by the detailed description of the exemplary embodiments but by the appended claims, and all differences within the scope will be construed as being included in the exemplary embodiments.

1. A video decoding method comprising:
obtaining a first data unit parallel processing flag indicating whether parallel processable data is included in a first data unit from a first data unit header, the first data unit header comprising encoding information of the first data unit that constitutes a video included in a bitstream;
determining whether parallel processable data is included in the first data unit based on the first data unit parallel processing flag; and
in response to determining that parallel processable data is included in the first data unit, obtaining a second data unit parallel processing flag indicating whether parallel processable data is included in a second data unit, whose level is lower than a level of the first data unit, from a second data unit header comprising encoding information of the second data unit.

2. The video decoding method of claim 1, wherein the first data unit is a sequence, the second data unit is a picture, the first data unit header is a sequence parameter set (SPS), and the second data unit header is a picture parameter set (PPS).

3. The video decoding method of claim 1, further comprising:
determining whether parallel processable data is included in the second data unit based on the second data unit parallel processing flag; and
in response to determining that parallel processable data is included in the second data unit, obtaining a third data unit parallel processing flag indicating whether parallel processable data is included in a third data unit, whose level is lower than the level of the second data unit, from a third data unit header comprising encoding information of the third data unit.

4. The video decoding method of claim 3, wherein the second data unit is a picture and the third data unit is a slice.

5. The video decoding method of claim 1, wherein each of the first data unit header and the second data unit header comprises additional parallel processing information, and
wherein in response to the same parallel processing information being included in the first data unit header and the second data unit header, the parallel processing information included in the second data unit header has a higher priority than the parallel processing information included in the first data unit header, and the parallel processing information of the second data unit header replaces the parallel processing information of the first data unit header.

6. The video decoding method of claim 1, wherein the parallel processable data is data related to at least one selected from a tile, wavefront parallel processing (WPP), and a slice.

7. A video decoding apparatus comprising:
a parallel processing information obtainer that is configured to obtain a first data unit parallel processing flag indicating whether parallel processable data is included in a first data unit that constitutes a video included in a bitstream from a first data unit header comprising encoding information of the first data unit, and in response to determining that parallel processable data is included in the first data unit based on the first data unit parallel processing flag, to obtain a second data unit parallel processing flag indicating whether parallel processable data is included in a second data unit, whose level is lower than a level of the first data unit, from a second data unit header comprising encoding information of the second data unit; and
a parallel processing determiner that is configured to determine that a parallel processable data unit is included in the video based on the obtained first data unit parallel processing flag and the obtained second data unit parallel processing flag.

8. The video decoding apparatus of claim 7, wherein the first data unit is a sequence, the second data unit is a picture, the first data unit header is a sequence parameter set (SPS), and the second data unit header is a picture parameter set (PPS).

9. The video decoding apparatus of claim 7, wherein the parallel processing information obtainer is further configured to determine whether parallel processable data is included in the second data unit based on the second data unit parallel processing flag, and in response to determining that parallel processable data is included in the second data unit, to obtain a third data unit parallel processing flag indicating whether parallel processable data is included in a third data unit, whose level is lower than the level of the second data unit, from a third data unit header comprising encoding information of the third data unit.

10. The video decoding apparatus of claim 9, wherein the second data unit is a picture and the third data unit is a slice.

11. The video decoding apparatus of claim 7, wherein each of the first data unit header and the second data unit header comprises additional parallel processing information, and in response to the same parallel processing information being included in the first data unit header and the second data unit header, the parallel processing information included in the second data unit header has a higher priority than the parallel processing information included in the first data unit header,
wherein the parallel processing information obtainer is further configured to replace the parallel processing information of the first data unit header with the parallel processing information of the second data unit header.

12. The video decoding apparatus of claim 7, wherein the parallel processable data is data related to at least one selected from a tile, wavefront parallel processing (WPP), and a slice.

13. A video encoding method comprising:
obtaining encoded data of a first data unit that constitutes a video and a second data unit whose level is lower than a level of the first data unit;
encoding a first data unit parallel processing flag indicating whether parallel processable data is included in the first data unit and outputting the encoded first data unit parallel processing flag to a first data unit header comprising encoding information of the first data unit; and
in response to parallel processable data being included in the first data unit, encoding a second data unit parallel processing flag indicating whether parallel processable data is included in the second data unit and outputting the encoded second data unit parallel processing flag to a second data unit header.

14. The video decoding method of claim 13, wherein each of the first data unit header and the second data unit header comprises additional parallel processing information, and in response to the same parallel processing information being included in the first data unit header and the second data unit header, the parallel processing information included in the second data unit has a higher priority than the parallel processing information included in the first data unit header, and
wherein the parallel processing information of the second data unit header replaces the parallel processing information of the first data unit header.

15. A video encoding apparatus comprising:
a parallel processing determiner that is configured to obtain encoded data of a first data unit that constitutes a video and a second data unit whose level is lower than a level of the first data unit, and to determine whether parallel processable data is included in the first data unit and the second data unit; and
a parallel processing information output unit that is configured to encode a first data unit parallel processing flag indicating whether parallel processable data is included in the first data unit and output the encoded first data unit parallel processing flag to a first data unit header comprising encoding information of the first data unit, and in response to parallel processable data being included in the first data unit, to encode a second data unit parallel processing flag indicating whether parallel processable data is included in the second data unit and output the encoded second data unit parallel processing flag to a second data unit header.

16. A video decoding method comprising:
obtaining, from a first data unit header, a first data unit parallel processing flag indicating whether parallel processable data is included in a first data unit;
determining whether parallel processable data is included in the first data unit based on the first data unit parallel processing flag; and
in response to determining that parallel processable data is included in the first data unit, obtaining, from a second data unit header, a second data unit parallel processing flag indicating whether parallel processable data is included in a second data unit, the second data unit being of a lower than a level of the first data unit.

17. The video decoding method of claim 16, wherein the first data unit is a sequence, the second data unit is a picture, the first data unit header is a sequence parameter set (SPS), and the second data unit header is a picture parameter set (PPS).

18. The video decoding method of claim 16, further comprising:
determining whether parallel processable data is included in the second data unit based on the second data unit parallel processing flag; and
in response to determining that parallel processable data is included in the second data unit, obtaining, from a third data unit header, a third data unit parallel processing flag indicating whether parallel processable data is included in a third data unit, the third data unit being of a lower level than the level of the second data unit.
